(19) United States
(12) Patent Application Publication
(10) Pub. No.: US 2018/0045370 A1
(43) Pub. Date: Feb. 15, 2018

(54) GAS STORAGE CONTAINER FOR INFLATOR AND PROCESS FOR MANUFACTURING SAME

(71) Applicants: TOYODA GOSEI CO., LTD., Kiyosu-shi (JP); MARUYOSHI KOGYO CO., LTD., Kakamigahara-shi (JP)

(72) Inventors: Kengo NAKASHIMA, Kiyosu-shi (JP); Takashi UEMURA, Kiyosu-shi (JP); Keisuke MORI, Kiyosu-shi (JP); Yuichiro TSUCHIDA, Kakamigahara-shi (JP)

(21) Appl. No.: 15/664,198

(22) Filed: Jul. 31, 2017

(30) Foreign Application Priority Data
Aug. 10, 2016 (JP) 2016-157833

(51) Int. Cl. F17C 1/00; B21K 21/04; C22C 38/02; C22C 38/00; C22C 38/44; C22C 38/04

(52) U.S. Cl. CPC F17C 1/00; C22C 38/44; C22C 38/04; C22C 38/02; C22C 38/002; B21K 21/04; F17C 2203/0639; F17C 2209/2181; F17C 2221/014; F17C 2221/016; F17C 2260/011; F17C 2270/0772

(57) ABSTRACT

Disclosed is a gas storage container for an inflator, the container being formed by cold forging a steel material having a predetermined steel composition. The steel composition by mass percent of the steel material includes, C: 0.10% to 0.31%, Si: 0.13% to 0.39%, Mn: 0.49% to 1.05%, P: 0.03% or less, S: 0.03% or less, Ni: 0.28% or less, Cr: 0.76% to 1.38%, Mo: 0.13% to 0.33%, and a remainder of Fe and unavoidable impurities.

### CROSS REFERENCE TO RELATED APPLICATIONS

The present application claims priority from Japanese Patent Application No. 2016-157833 of Nakashima et al., filed on Aug. 10, 2016, the entire disclosure of which is incorporated herein by reference.

### BACKGROUND OF THE INVENTION

### 1. Field of the Invention

The present invention relates to a gas storage container for an inflator, the container being formed by cold forging a predetermined steel material and a process for manufacturing same. The inflator is used in an airbag device mounted on a vehicle or the like to supply the inflating gas to the folded airbag.

### 2. Description of Related Art

In the related art, as a gas storage container of an inflator, a steel material having a predetermined steel composition was first formed into a seamless pipe body by hot working, cut into a predetermined length dimension, and cold working was further performed so as to have a predetermined bottle shape. Thereafter, in order to remove distortion and the like, it has been manufactured by applying heat treatment such as quenching and tempering (for example, refer to JP-A-2002-194501).

Such a gas storage container for an inflator is used for a hybrid type inflator in which an inactive pressurized gas made of argon gas, nitrogen gas or the like is sealed inside (for example, refer to JP-A-2010-002005). In this type of inflator, the filling port is formed by boring working in the gas storage container for an inflator manufactured so that pressurized gas can be filled therein, and the squib to discharge the pressurized gas is disposed or the discharge port portion for discharging the mixed gas of pressurized gas and combustion gas of squib is disposed. Therefore, these members (more specifically, a mouthpiece portion provided with the squib or the discharge port portion) are attached by welding. Incidentally, the gas storage container has been able to be used as the hybrid type inflator if the pressurized gas was sealed from the filling port, a closing material was welded to the filling port and attached, and the filling port was closed.

However, in the gas storage container for an inflator in the related art, a steel material was hot-worked to form a seamless pipe body, subsequently cut to a predetermined length, cold-worked, and further heat-treated to manufacture the gas storage container. Therefore, in the gas storage container for an inflator in the related art, there were many manufacturing processes, and there was a problem of whether or not a product having appropriate strength and suitable for subsequent workability and weldability can be easily obtained.

### SUMMARY OF THE INVENTION

The invention is to solve the above-mentioned problem, and an object is to easily provide a gas storage container for an inflator which has suitable strength and can be worked and welded without any trouble and a process for manufacturing same.

The present inventors have developed a gas storage container for an inflator which can be manufactured by omitting a plurality of processes such as hot working, cold working, heat treatment, and the like in the related art, ensure low temperature toughness so that the obtained gas storage container for an inflator can prevent brittle fracture at low temperature in cold climates and the like, have a suitable strength so as to ensure a predetermined pressure resistance strength, that is, a predetermined high burst pressure, and can further perform working such as cutting and welding without causing problems such as cracking.

According to the invention, there is provided a gas storage container for an inflator, the container being formed by cold forging a steel material having a predetermined steel composition. The steel composition of the steel material includes, by mass percent, C: 0.10% to 0.31%, Si: 0.13% to 0.39%, Mn: 0.49% to 1.05%, P: 0.03% or less, S: 0.03% or less, Ni: 0.28% or less, Cr: 0.76% to 1.38%, Mo: 0.13% to 0.33%, and a remainder of Fe and unavoidable impurities.

In the gas storage container for an inflator, the container being obtained by cold forging the steel material having such a steel composition, welding and working can be suitably performed with appropriate carbon content, and the gas storage container has an appropriate hardness due to work hardening by cold forging. Therefore, it is possible to obtain a predetermined strength (pressure resistance strength) without causing brittle fracture at low temperature.

Therefore, the gas storage container for an inflator according to the invention has suitable strength and can exhibit workability and weldability that allow working and welding without any trouble by a simple process of only cold forging the steel material having the predetermined steel composition without heat treatment.

In the gas storage container for an inflator according to the invention, it is preferable that the steel composition of the steel material has a carbon equivalent within a range of 0.375% to 0.865%.

That is, regarding the steel composition of the steel material used for cold forging, when the carbon equivalent is less than 0.375%, work hardening by cold forging is not sufficient, and it is difficult to obtain a predetermined pressure resistance strength, and when the carbon equivalent exceeds 0.865%, the steel material becomes too hard due to work hardening by cold forging and becomes brittle, it is difficult to obtain predetermined pressure resistance strength (low temperature toughness) at low temperature, and cracks and fractures are generated during working and welding, which are not preferable.

Therefore, when the carbon equivalent of the steel composition of the steel material is within the range of 0.375% to 0.865%, it is possible to obtain more preferable strength, good workability, and weldability.

According to the invention, there is provided a process for manufacturing a gas storage container for an inflator, the container being manufactured from a steel material having a predetermined steel composition, in which the steel material is manufactured by cold forging, and the steel composition of the steel material includes, by mass percent, C: 0.10% to 0.31%, Si: 0.13% to 0.39%, Mn: 0.49% to 1.05%, P: 0.03% or less, S: 0.03% or less, Ni: 0.28% or less, Cr: 0.76% to 1.38%, Mo: 0.13% to 0.33%, and a remainder of Fe and unavoidable impurities.

In the process for manufacturing according to the invention, it is possible to easily manufacture the gas storage container for an inflator that has a suitable strength and can perform working and welding without any trouble by cold forging the predetermined steel material without heat treatment as an inflator.

In the process for manufacturing the gas storage container for an inflator according to the invention, as long as the carbon equivalent of the steel composition of the steel material is within the range of 0.375% to 0.865%, it is possible to manufacture the gas storage container for an inflator which can ensure more preferable strength and workability.

Furthermore, in the process for manufacturing the gas storage container for an inflator according to the invention, it is preferable that an area reduction rate of the cold forging of the steel material is within a range of 80% to 90%.

With such a configuration, it is possible to obtain hardness due to predetermined work hardening while suppressing an increase in the number of working steps and working energy, and the gas storage container for an inflator that can obtain workability and weldability which do not generate cracks and fractures and can ensure suitable low temperature toughness.

### BRIEF DESCRIPTION OF THE DRAWINGS

FIG. 1 is a side view of a gas storage container for an inflator according to an embodiment of the invention.

FIG. 2 is a cross-sectional view of the gas storage container for an inflator of FIG. 1, corresponding to the II-II portion of FIG. 1.

FIG. 3 is a side view of a housing worked for use in manufacturing an inflator.

FIG. 4 is a cross-sectional view of the housing of FIG. 3, corresponding to the IV-IV portion of FIG. 3.

FIG. 5 is a cross-sectional view illustrating an inflator manufactured using the gas storage container for an inflator of the embodiment.

### DESCRIPTION OF THE PREFERRED EMBODIMENTS

Preferred embodiments of the present invention are described below with reference to accompanying drawings. However, the invention is not limited to the embodiments disclosed herein. All modifications within the appended claims and equivalents relative thereto are intended to be encompassed in the scope of the claims.

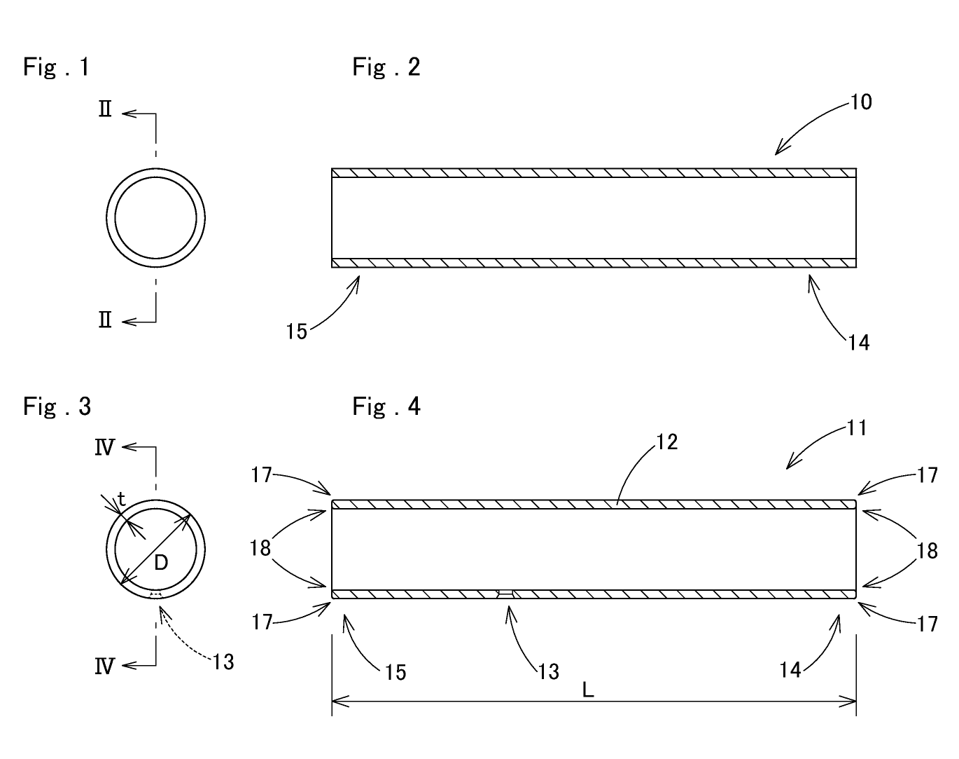

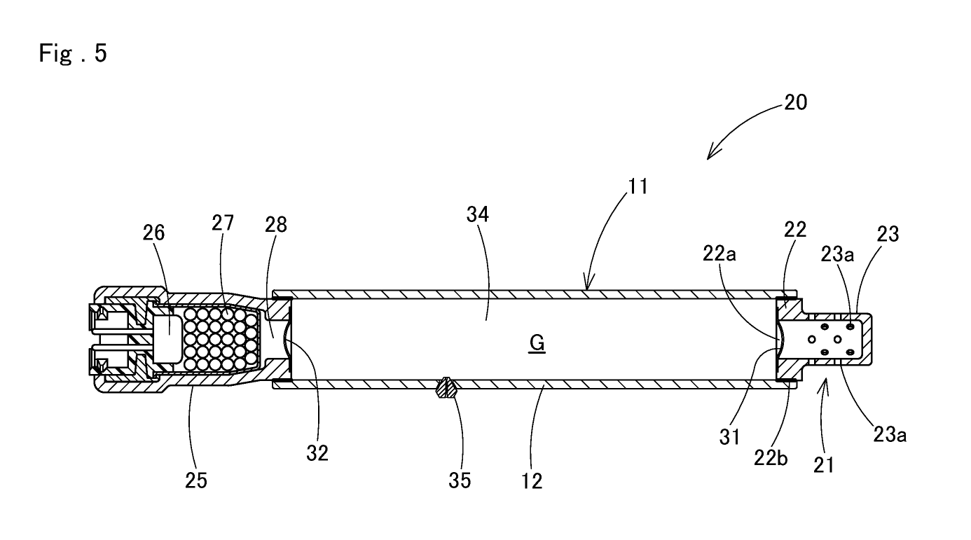

As illustrated in FIGS. 1 and 2, a steel pipe material 10 as a gas storage container for an inflator according to an embodiment is formed of a steel pipe in which opening ends 14 and 15 opened circularly are disposed at both ends. As described later, the steel pipe material 10 is formed by cold forging a columnar steel material (blank) having a predetermined steel composition. The steel pipe material 10 is provided with a filling port 13 for filling pressurized gas on a cylindrical peripheral wall portion 12 by boring working, and is provided with corner finishing surfaces 17 and 18 on edges of inner and outer circumference of the opening ends 14 and 15 by cutting working. Therefore, as illustrated in FIGS. 3 to 5, the steel pipe material 10 is formed in a housing (bottle) 11. As described later, a discharge side mouthpiece portion 21, a squib side mouthpiece portion 25, and the like are attached in the housing 11 and filled with a predetermined pressurized gas G to be used as an inflator 20.

The chemical composition of the steel material forming the steel pipe material 10 and percent by mass thereof are as follows.

C: 0.10% to 0.31%

C is an element effective for inexpensively obtaining the required strength of steel, but when C is less than 0.10%, strength due to work hardening by cold forging, that is, sufficient pressure resistance strength for an inflator can hardly be obtained, and when C exceeds 0.31%, the workability and weldability are reduced, so that C is set to 0.10% to 0.31%. Preferably, the percent by mass of C is 0.12% to 0.18%. In the case of the embodiment, the percent by mass of C is set to 0.14%.

Si: 0.13% to 0.39%

Si is an element contributing to the improvement of the strength of the steel, and it is necessary to be 0.13% or more, but when Si exceeds 0.35%, the toughness is reduced, so that Si is set to 0.13% to 0.39%. Preferably, the percent by mass of Si is 0.15% to 0.35%. In the case of the embodiment, the percent by mass of Si is set to 0.19%.

Mn: 0.49% to 1.05%

Mn is an element effective for improving the strength and toughness of steel, but when Mn is less than 0.49%, sufficient strength and toughness cannot be obtained, and when Mn exceeds 1.05%, weldability is deteriorated, so that Mn is 0.49% to 1.05%. Preferably, the percent by mass of Mn is 0.55% to 0.95%. In the case of the embodiment, the percent by mass of Mn is set to 0.77%.

P: 0.03% or Less

P is contained as an impurity in the steel, but P causes a decrease in toughness due to grain boundary segregation, so that P is set to 0.03% or less. Specifically, in the case of the embodiment, the percent by mass of P is set to 0.011%.

S: 0.03% or Less

S is contained as an impurity in the steel, but S is combined with Mn in the steel to form inclusions due to MnS, which deteriorates workability and toughness, so that S is set to 0.03% or less. Specifically, in the case of the embodiment, the percent by mass of S is set to 0.008%.

Ni: 0.28% or Less

Ni is an effective element for improving toughness, but Ni is expensive, and even when Ni exceeds 0.28%, the merit of toughness improvement is offset, so that Ni is set to 0.28% or less. Preferably, the percent by mass of Ni is 0.25% or less. In the case of the embodiment, the percent by mass of Ni is set to 0.03%.

Cr: 0.76% to 1.38%

Cr is an effective element for improving the strength, toughness, and corrosion resistance of the steel, but when Cr is less than 0.76%, Cr is ineffective, and when Cr exceeds 1.38%, workability and toughness of the welded portion are reduced, so that Cr is set to 0.76% to 1.38%. Preferably, the percent by mass of Cr is 0.85% to 1.25%. In the case of the embodiment, the percent by mass of Cr is set to 1.13%.

Mo: 0.13% to 0.33%

Mo is an element for improving strength and toughness, but when Mo is less than 0.13%, Mo is ineffective, and when Mo exceeds 0.33%, weld portion is cured and toughness is rather reduced, so that Mo is 0.13% to 0.33%. Preferably, the percent by mass of Mo is 0.15% to 0.30%. In the case of the embodiment, the percent by mass of Mo is set to 0.16%.

A remainder is Fe except for unavoidable impurities.

Furthermore, it is desirable that the steel material for forming the steel pipe material 10 has a following carbon equivalent, on condition that each of the chemical components falls within the above-described range of mass percent.

Calculation formula of carbon equivalent is

Carbon equivalent Ceq (%)=C+(Si/24)+(Mn/6)+(Ni/40)+(Cr/5)+(Mo/4)+(V/14).

The carbon equivalent of the steel material forming the steel pipe material 10 is within the range of 0.375% to 0.865%. That is, regarding the steel composition of the steel material used for cold forging, when the carbon equivalent is less than 0.375%, work hardening by cold forging is not sufficient, and it is difficult to obtain a predetermined pressure resistance strength, and when the carbon equivalent exceeds 0.865%, the steel material becomes too hard due to work hardening by cold forging and becomes brittle, it is difficult to obtain predetermined pressure resistance strength (low temperature toughness) at low temperature, and cracks and fractures are generated during working and welding, which are not preferable. It is desirable that the carbon equivalent of the steel material in consideration of the above-described preferable range is in the range of 0.425% to 0.684%. In the case of the embodiment, the carbon equivalent of the steel material is set to 0.542%.

A cylindrical steel pipe material 10 can be obtained by cold forging a columnar blank having such a steel composition by a predetermined number of working steps without performing hot working or heat treatment, and cutting the end portion.

It is desirable that an area reduction rate from the steel material is within the range of 80% to 90%. With such a configuration, this is because it is possible to obtain hardness due to predetermined work hardening while suppressing an increase in the number of working steps and working energy, and the steel pipe material 10 that can obtain workability and weldability which do not generate cracks and fractures and can ensure suitable low temperature toughness. The area reduction rate of the embodiment is set to 86%.

As illustrated in FIG. 1, the steel pipe material 10 obtained in this manner is provided with the filling port 13 for filling a pressurized gas on the cylindrical peripheral wall portion 12 by boring working, and is provided with the corner finishing surfaces 17 and 18 on edges of inner and outer circumference of the opening ends 14 and 15 by cutting working. Therefore, the housing (bottle) 11 is formed in the steel pipe material 10.

In the housing 11 of the illustrated example manufactured in the embodiment, the outer diameter dimension D is 25 mm, the wall thickness dimension t is 2 mm, and the length dimension L is 139.2 mm.

In the housing 11, an outer peripheral surface 22b side of a base portion 22 of the discharge side mouthpiece portion 21 is fixed to the inner peripheral side of the opening end 14, by welding such as resistance welding, and the squib side mouthpiece portion 25 holding a gas generating agent 27 and a squib 26 which ignites the gas generating agent 27 is fixed to the inner peripheral side of the opening end 15 by welding such as resistance welding. The discharge side mouthpiece portion 21 has a gas discharge portion 23 provided with a plurality of gas discharge ports 23a projecting therefrom.

Rupture discs 31 and 32 that close the housing 11 side so as to be rupturable due to shock waves due to ignition of the squib 26, or internal pressure rise by ignition of the gas generating agent 27, are disposed at boundaries between the discharge side mouthpiece portion 21 and the squib side mouthpiece portion 25 in the housing 11, that is, at an inflow port 22a of the base portion 22 of the discharge side mouthpiece portion 21 and an outflow port 28 of the squib side mouthpiece portion 25, respectively. An inflator 20 can be formed by filling a filling chamber 34 between the discharge side mouthpiece portion 21 and the squib side mouthpiece portion 25 in the housing 11 with an inactive pressurized gas G such as argon gas or nitrogen gas from the filling port 13 and welding a closing body 35 made of steel to the filling port 13 to close the filling port 13. Specifically, a gas flow path is previously opened in the closing body 35, the closing body 35 is inserted into the filling port 13, and the pressurized gas G is filled into the filling chamber 34 via the gas flow path. The closing body 35 is resistance-welded to the peripheral wall portion 12, and at that time, the gas flow path of the closing body 35 is closed by melt and solidification of the steel material of the closing body 35 itself, and thus the inflator 20 is manufactured.

In the inflator 20 manufactured in this manner, when the squib 26 is ignited and the gas generating agent 27 ignites during operation, the rupture disks 32 and 31 rupture and the mixed gas of the combustion gas of the gas generating agent 27 and the pressurized gas is discharged from the gas discharge port 23a of the gas discharge portion 23.

The steel pipe material 10 (housing 11) as the gas storage container for an inflator of the embodiment is formed by cold forging only from the steel material of the predetermined steel composition without heat treatment, so that welding and working can be preferably performed. The predetermined strength (pressure resistance strength) can be obtained without causing brittle fracture at low temperature due to an appropriate hardness by work hardening by cold forging. Therefore, steel pipe material 10 can be suitably used as the inflator 20.

In addition, in the process for manufacturing the steel pipe material 10 (housing 11) as the gas storage container for an inflator of the embodiment, it is possible to easily manufacture the gas storage container for an inflator that has a suitable strength and can perform working and welding without any trouble by using the steel material having the predetermined steel composition, and only by cold forging without hot working or heat treatment.

Incidentally, in the inflator 20 including the steel pipe material 10 of the embodiment, it is possible to ensure a burst pressure of approximately 176 Mpa or more, and even in a tank test of approximately −40° C. to −100° C., breakage of the housing 11 does not occur.

What is claimed is:

1. A gas storage container for an inflator, the container being formed by cold forging a steel material having a predetermined steel composition,
wherein the steel composition of the steel material includes, by mass percent,
C: 0.10% to 0.31%, Si: 0.13% to 0.39%, Mn: 0.49% to 1.05%, P: 0.03% or less, S: 0.03% or less, Ni: 0.28% or less, Cr: 0.76% to 1.38%, Mo: 0.13% to 0.33%, and a remainder of Fe and unavoidable impurities.

2. The gas storage container for an inflator according to claim 1,
wherein the steel composition of the steel material has a carbon equivalent within a range of 0.375% to 0.865%.

3. A process for manufacturing a gas storage container for an inflator, the container being manufactured from a steel material having a predetermined steel composition,
wherein the steel material is manufactured by cold forging, and
the steel composition of the steel material includes, by mass percent,
C: 0.10% to 0.31%, Si: 0.13% to 0.39%, Mn: 0.49% to 1.05%, P: 0.03% or less, S: 0.03% or less, Ni: 0.28% or less, Cr: 0.76% to 1.38%, Mo: 0.13% to 0.33%, and a remainder of Fe and unavoidable impurities.

4. The process for manufacturing the gas storage container for an inflator according to claim 3,
wherein the steel composition of the steel material has a carbon equivalent within a range of 0.375% to 0.865%.

5. The process for manufacturing the gas storage container for an inflator according to claim 3,
wherein an area reduction rate of the cold forging of the steel material is within a range of 80% to 90%.

6. The process for manufacturing the gas storage container for an inflator according to claim 4,
wherein an area reduction rate of the cold forging of the steel material is within a range of 80% to 90%.
